(19) United States
(12) Patent Application Publication
(10) Pub. No.: US 2007/0260522 A1
(43) Pub. Date: Nov. 8, 2007

(54) Boomtime services

(76) Inventor: William F. Bice, Sandia Park, NM (US)

Correspondence Address: Richard H. Krukar;Attorney, Intellectual Property, Ortiz & Lopez, PLLC, P.O. Box 4484, Albuquerque, NM, 87196-4484, US

(21) Appl. No.: 11/708,879

(22) Filed: Feb. 20, 2007

Related U.S. Application Data
(60) Provisional application No. 60/798,280, filed on May 4, 2006.

(51) Int. Cl. G06Q 30/00

(52) U.S. Cl. 705/14

(57) ABSTRACT

A facilitator, such as SpaBoom, can provide an organization, such as a health spa, with an instant gift certificate capability. The organization instantly recognizes revenue on instant gift certificates that contain customized terms and conditions based on the organization's jurisdiction. The facilitator's web site can provide the organization with online tools for designing an instant gift certificate offer page and for designing the instant gift certificates themselves. Alternatively, the facilitator can provide a back end processing capability while the organization produces all, or some of, the web pages and related graphics.

### CROSS REFERENCE TO RELATED APPLICATIONS

This patent application claims the priority and benefit of U.S. Provisional Patent Application No. 60/798,280 filed on May 4, 2006 entitled “BoomTime” and which is incorporated herein by reference in its entirety.

### TECHNICAL FIELD

Embodiments relate to the fields of personal services related businesses, gift certificates, web browsers, web sites, and web pages. Embodiments also relate to web based layout tools, web page design, design templates, databases, and internet based commerce.

### BACKGROUND

Many small businesses do, or desire to, offer gift certificates. One common solution is to simply write the gift details on a preprinted certificate form. An employee of the business can sign the certificate as proof of its veracity. Another, much newer, solution is to use the services of an aggregator. For example, a gift certificate can be bought from Amazon.com and redeemed by purchasing goods from Amazon.com or one of its affiliates. In an aggregation model, the aggregator receives the funds when the gift certificate is sold.

In some aggregation schemes the gift certificate is redeemed, or cashed in, at the aggregator and some of the proceeds are then passed to the affiliate. In other aggregation schemes, the gift certificate is redeemed at the affiliate. The affiliate then presents the gift certificate to the aggregator at which time the aggregator pays the associate. In either case, the aggregator holds the money used to buy all the certificates that have been sold and not yet redeemed. The aggregator makes a particularly healthy profit from gift certificates that are never redeemed.

Web site design tools have existed for almost as long as the web itself. Some tools provide systems and methods for building Internet stores. For example, Cafe Press offers systems and methods for creating an Internet t-shirt store. Designs can be entered. Also, web pages for presenting designs and taking orders are provided. The back end databases for supporting the t-shirt store are also provided, as are systems for payment, t-shirt production, and shipping. Customers, however, associate the transaction with Cafe Press because the materials are branded as such.

Many businesses use preprinted gift certificate forms in order to immediately receive the gift certificate revenue, but they usually can not track outstanding certificates or sell electronic gift certificates over the internet. An electronic gift certificate is a gift certificate that a customer can purchase over the internet and then print out.

Other businesses use an aggregator to provide gift certificates. The gift certificates have terms and conditions that are designed to simultaneously comply with every one of the anticipated legal jurisdictions of the businesses and their customers. As such, they loose advantages provided by local or state statutes.

Systems and methods are needed to supply business with a gift certificate solution that overcomes limitations in the currently available solutions.

### BRIEF SUMMARY

The following summary is provided to facilitate an understanding of some of the innovative features unique to the embodiments and is not intended to be a full description. A full appreciation of the various aspects of the embodiments can be gained by taking the entire specification, claims, drawings, and abstract as a whole.

Limitations in current technology can be addressed by providing systems and methods for supplying businesses with a gift certificate solution where the business immediately receives the gift certificate revenue, where the terms and conditions are sensitive to specific legal jurisdictions, and where the business can sell electronic gift certificates.

It is therefore an aspect of the embodiments to serve a facilitator website on the internet. An organization, such as a health spa, can register itself with the facilitator by providing organization information to the facilitator web site. The organization information includes the organizations jurisdiction. For example, the state field or zip code field in an organization's address can indicate jurisdiction. Lawyers are familiar with legal jurisdictions, commonly also referred to simply as jurisdictions.

It is also an aspect of the embodiments that the organization can specify gift certificates through the facilitator web site. The facilitator website provides a means for an organization to provide a gift certificate specification to the facilitator.

It is an additional aspect of the embodiments to obtain customer information. The customer information can include a customer's address and billing information. The customer information can be obtained directly from the customer by serving a web form that the customer fills in. Similarly, the customer can provide the organization with the customer information such that the customer information is then obtained from the organization.

It is another aspect of the embodiments to select customized terms and conditions based on the organization jurisdiction. Different jurisdictions can have different laws governing gift certificates. For example, some jurisdictions allow a gift certificate to expire if it is unredeemed for a long enough time. Some jurisdictions require a purchaser to be reimbursed for an expired gift certificate while others allow the organization to retain the money.

It is a further aspect of the embodiments to use the organization information, customer information, and gift certificate specification to produce an instant gift certificate. An instant gift certificate is a gift certificate than can be immediately printed by the customer, emailed to the customer, or printed out and then mailed to the customer. The instant gift certificate includes the customized terms and conditions.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a high level flow diagram of setting up an organization in accordance with aspects of the embodiments;

FIG. 2 illustrates a high level block diagram of providing an instant gift certificate ordering capability to an organization in accordance with aspects of certain embodiments;

FIG. 3 illustrates a high level block diagram of receiving customer information from an organization and providing an instant gift certificate in accordance with aspects of certain embodiments;

FIG. 4 illustrates a high level block diagram of receiving a gift certificate request and responding with gift certificate data in accordance with aspects of certain embodiments;

FIG. 5 illustrates high level block diagrams of a gift certificate request and a gift certificate response in accordance with aspects of certain embodiments;

FIG. 6 illustrates a high level block diagram of entities involved in instant gift certificate transactions in accordance with aspects of the embodiments;

FIG. 7 illustrates a high level block diagram of modules that a facilitator can use in processing instant gift certificate transactions in accordance with aspects of the embodiments;

FIG. 8 illustrates a table of terms and conditions in accordance with aspects of the embodiments;

FIG. 9 illustrates a web page that a facilitator can serve to an organization for designing an instant gift certificate offer page in accordance with aspects of certain embodiments;

FIG. 10 illustrates a web page that a facilitator can serve to an organization for designing an instant logo and instant gift certificates in accordance with aspects of certain embodiments; and

FIG. 11 illustrates a high level block diagram of a template that a facilitator can provide an organization for sending instant gift certificate requests and receiving instant gift certificate responses in accordance with aspects of certain embodiments.

### DETAILED DESCRIPTION

A facilitator, such as SpaBoom, can provide an organization, such as a health spa, with an instant gift certificate capability. The organization instantly recognizes revenue on instant gift certificates that contain customized terms and conditions based on the organization's jurisdiction. The facilitator's web site can provide the organization with online tools for designing an instant gift certificate offer page and for designing the instant gift certificates themselves. Alternatively, the facilitator can provide a back end processing capability while the organization produces all, or some of, the web pages and related graphics.

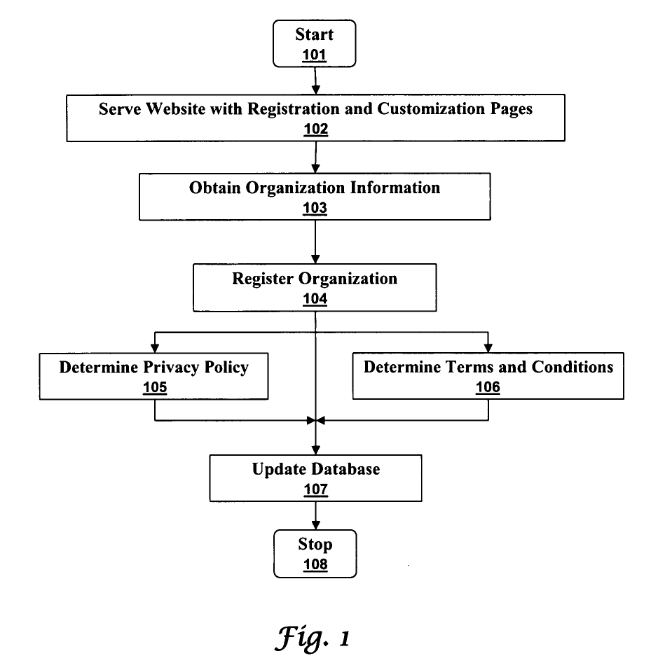

FIG. 1 illustrates a high level flow diagram of setting up an organization in accordance with aspects of the embodiments. After the start 101, a web site is served that has registration and customization pages 102. An organization can use the web site to provide information to the facilitator. After obtaining organization information 103 the organization is registered. The types of information required for registration include the organization's jurisdiction that can be used to determine a customized privacy policy 105 or customized terms and conditions 106. The organization's information can be stored in a database 107 before the process stops 108.

As with the laws governing gift certificates, privacy laws can vary from states to state as well as having a federal component. As such, organizations in different jurisdictions can have different privacy policies. The organization can publish the privacy policy to its customers.

The terms and conditions need not be produced as part of the set up process. They can be produced during set up, however, if they are unlikely to change after the initial set up. If they are produced during set up, then a way is needed to update them due to changes in jurisdiction, law, or other factors. As such, some embodiments will determine terms and conditions during set up, others will produce them at other times.

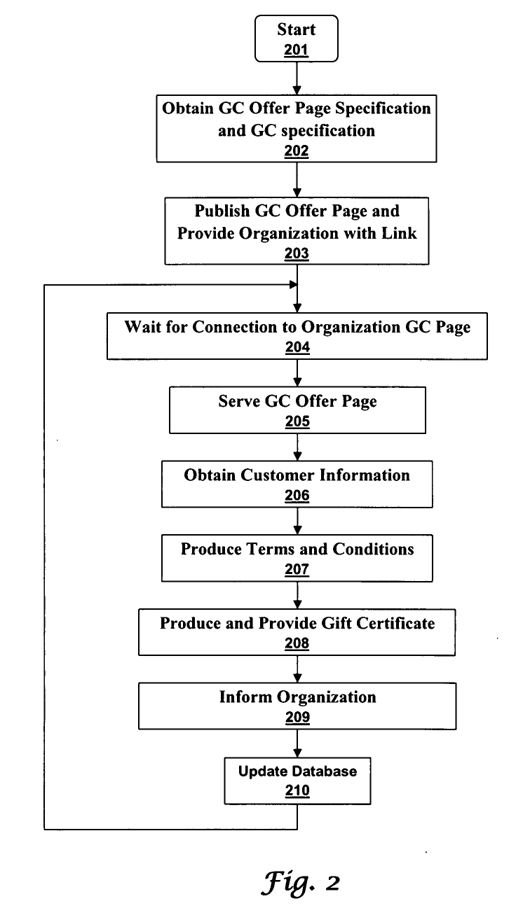

FIG. 2 illustrates a high level block diagram of providing an instant gift certificate ordering capability to an organization in accordance with aspects of certain embodiments. After the start 201, instant gift certificate offer page specifications and instant gift certificate specifications are obtained. The specifications specify the organization's design such as the background art, logo, font, and placement of text. The instant gift certificate offer page can then be published on a web server and the organization provided with a link to the page 203. The organization can publish the link to its customers.

A connection to the instant gift certificate offer page is then waited for 204 and the instant gift certificate offer page is served 205 upon receiving a connection. Customer information is then obtained 206, terms and conditions produced 207, and a gift certificate produced and provided 209 to the customer. The organization can be informed of the sale 209 and the database updated with the sale information 210. The process repeats to once again wait for a connection to the instant gift certificate offer page 204.

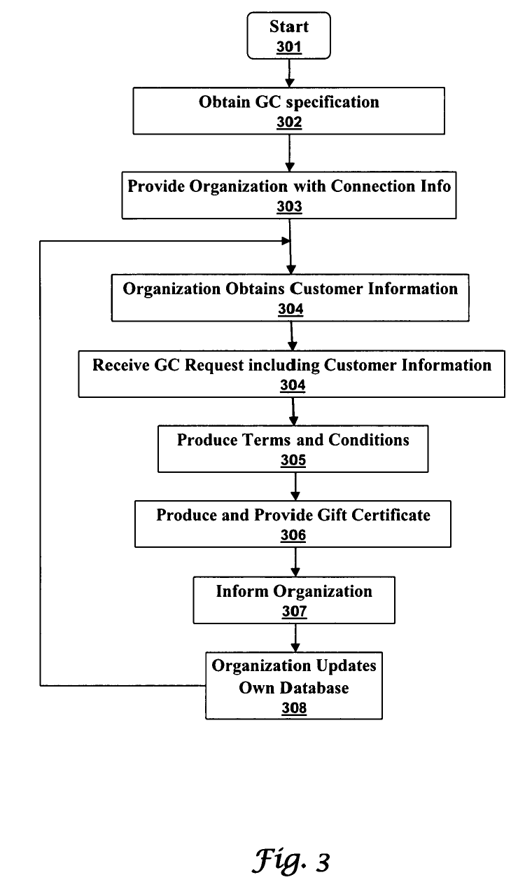

FIG. 3 illustrates a high level block diagram of receiving customer information from an organization and providing an instant gift certificate in accordance with aspects of certain embodiments. In this embodiment, the organization produces its own instant gift certificate offer page and sends customer information to the facilitator for instant gift certificate processing and fulfillment. After the start 301 the instant gift certificate specification is obtained from the organization 302 and the organization is provided with connection information 303. The organization obtains customer information 304 and, using the connection information, sends it in as part of an instant gift certificate request. The instant gift certificate request is received 304 and processed. Terms and conditions can be produced 305 and used when producing and providing the gift certificate 306. A gift certificate can be provided by serving it as a graphic image or web page from a server. The organization is informed of the sale 307 and updates its own database 308. The instant gift certificate facilitator can also update its database. The process loops back to the point at which the organization obtains information from customers 304.

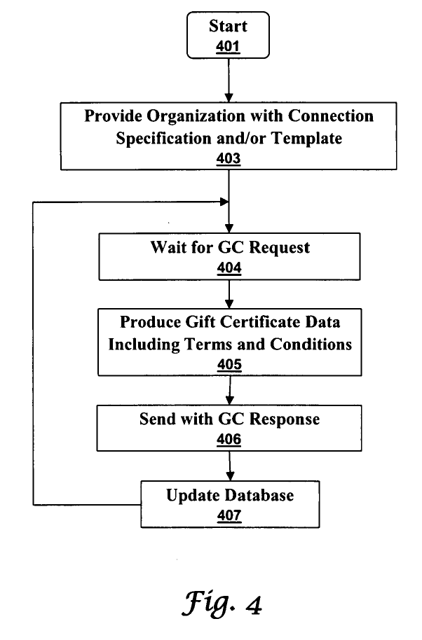

FIG. 4 illustrates a high level block diagram of receiving a gift certificate request and responding with gift certificate data in accordance with aspects of certain embodiments. After the start 401, an organization is provided with a connection specification, with a template, or both 403. A connection specification is a document telling the organization how to submit an instant gift certificate request and how to receive an instant gift certificate response. A template is one or more computer programs or modules that instantiate the connection specification. The organization can simply install the template, perhaps with some modifications, into its own computer systems and then be certain of compliant communications with the instant gift certificate facilitator. Those practiced in the art of computer communications protocols are familiar with connection specifications and templates.

An instant gift certificate request is waited for 404 and, when received, used to produce instant gift certificate data that includes terms and conditions 405. The instant gift certificate data is then incorporated into an instant gift certificate response that is sent back to the organization 406. The organization and/or the instant gift certificate facilitator can then update their databases with the sale information 407.

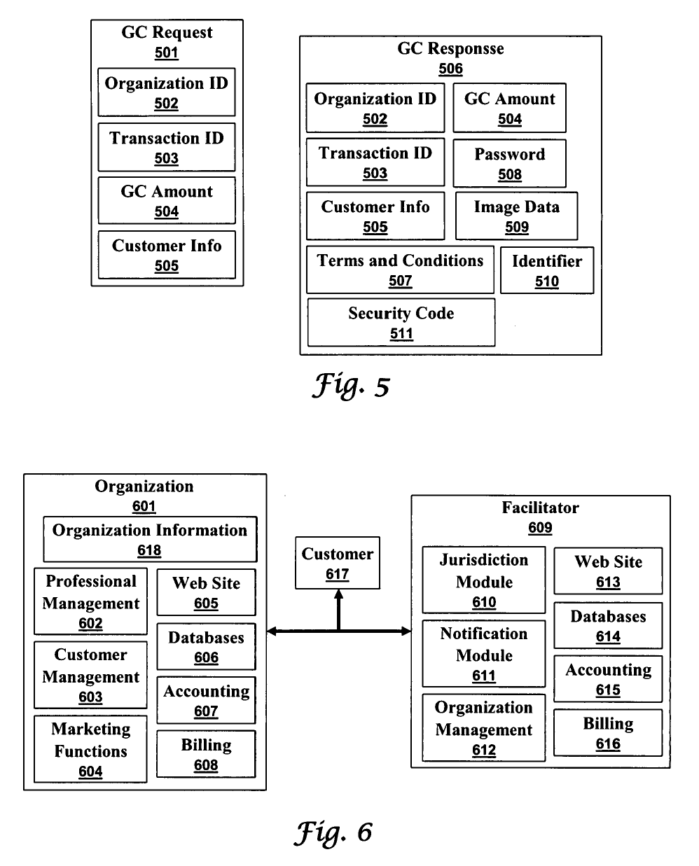

FIG. 5 illustrates high level block diagrams of a gift certificate request 501 and a gift certificate response 506 in accordance with aspects of certain embodiments. The gift certificate request is an electronic message, such as an internet protocol packet, sent from an organization to a facilitator. The request 501 can contain an organization Id, transaction Id 503, gift certificate amount 504, and customer information 505. An organization Id 502 indicates which organization sent the request. A transaction Id 503 can be used to identify specific transactions. A gift certificate amount 504 indicates the monetary value of the gift certificate. Alternatively, a service can be specified such as “1 hour deep massage” instead of a monetary value. Customer information 505 can contain details such as the customer's name, address, and billing information. Billing information is information such as billing address, and credit card number.

The gift certificate response 506 is an electronic message sent from a facilitator to an organization in response to a gift certificate request 501. A gift certificate response 506 can contain all the information contained in a gift certificate request 501 as well as a password 508, image data 509, terms and conditions 507, a gift certificate identifier 510, and a security code 511. A gift certificate identifier 510 can be used for tracking a specific gift certificate. For example, the gift certificate identifier, as well as any other identifier or Id, can be used as an index key in the organization's databases and the facilitator's data bases. The terms and conditions 507 can be customized based on the laws of the organization's legal jurisdiction, customer's legal jurisdiction, or both.

Image data 509 can be an encoded image, such as a JPEG image, that can be used as part of the gift certificate. For example, the image data can encode a gift certificate's background art, a bar code or other graphic that in turn encodes gift certificate information, or even an image of the entire gift certificate.

A security code 511 can be used to authenticate a gift certificate. Many ways of generating security code are known. For example, the data in the gift certificate response, other then security code, can be concatenated and submitted to a secure hash algorithm that in turn generates the security code 511.

A password 508 can be used to authenticate a gift certificate recipient (giftee). A password can be required from a giftee presenting a gift certificate to the organization. Alternatively, a customer can present themselves at an organization, such as a health spa, and supply a name and password such as “Megan” and “Happy Birthday”. As such, the giftee need not ever possess a physical gift certificate.

FIG. 6 illustrates a high level block diagram of entities involved in instant gift certificate transactions in accordance with aspects of the embodiments. An organization 601 can be a business, such as a health spa or beauty salon that uses the facilitator 609 in providing gift certificates to a customer 617. The organization has a legal jurisdiction, meaning the jurisdiction whose laws govern the organization. Organization information 618 can contain an address, the legal jurisdiction, and other data. The web site 605 is the organization's 601 virtual presence. Most organizations have databases that are used in support of billing 608, accounting 607, customer management 603, marketing functions 604, and professional management 602. Professionals can be the organization's employees, subcontractors, associates, or affiliates.

A facilitator 609 can have a web site 613 for registering organizations, serving gift certificate offer pages, or presenting gift certificates. The databases can support accounting 615, billing 616, organization management 612, the notification module 611, and jurisdiction module 610. The organization module can help facilitate interactions between the facilitator 609 and any registered organizations. The notification module 611 can be used to send messages to customers and giftees regarding gift certificate status and other matters. Billing 616 can be used for the facilitator's own billing functions, such as billing an organization 601 as well as for billing a customer 617. Some organizations directly bill customers for gift certificates and use the facilitator for other functions such as order taking and presentment. Other organizations also use the facilitator for the gift certificate billing function.

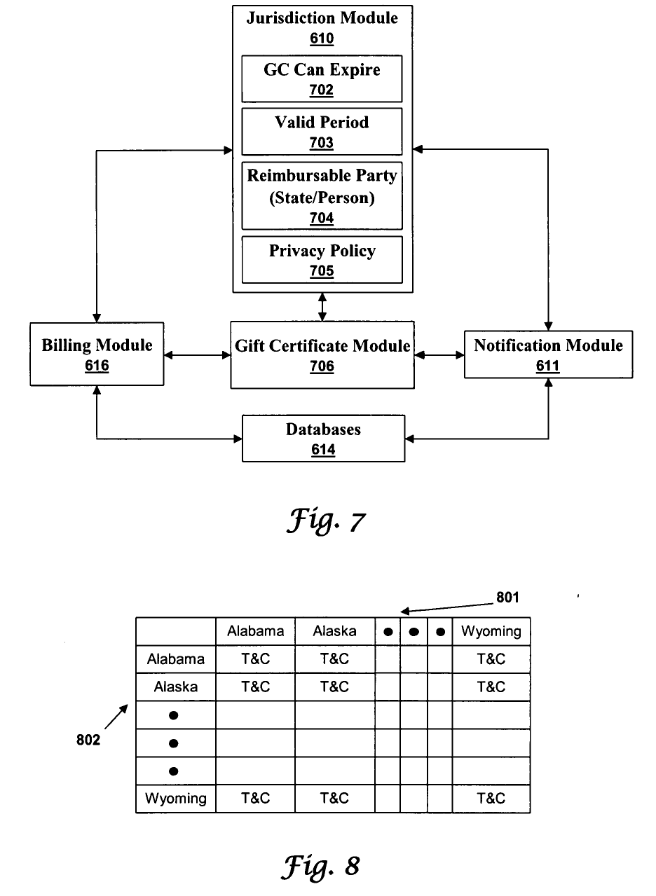

FIG. 7 illustrates a high level block diagram of modules that a facilitator can use in processing instant gift certificate transactions in accordance with aspects of the embodiments. The jurisdiction module 610 contains information pertinent to the different jurisdictions to which the organizations and customers are subject. Some of the data indicates if a gift certificate can expire in the jurisdiction 702, how long a gift certificate must be valid 703, who to reimburse when a gift certificate expires 704, and a jurisdiction compliant privacy policy 705. The jurisdiction module 610 can interact with the billing module 616, gift certificate module 706, notification module 611, and other modules. The gift certificate module 706 can obtain terms and conditions from the jurisdiction module 610 and place them on a gift certificate as governed by a gift certificate specification.

FIG. 8 illustrates a table of terms and conditions in accordance with aspects of the embodiments. The top row 801 labels the columns associated with organization jurisdictions. The leftmost row 802 labels rows associated with customer jurisdictions. Each “T&C” cell contains customized terms and conditions that are specifically written for each combination of organization jurisdiction and customer jurisdiction. In some embodiments, the customer jurisdiction is ignored and the table collapses to a single row of terms and conditions. In other embodiments, the organization jurisdiction is ignored and the table collapses to a single column of terms and conditions. A jurisdiction module can use a table to look up the customized terms and conditions that should be placed on a gift certificate. The terms and conditions can be authored by a lawyer reviewing the laws of the various jurisdictions.

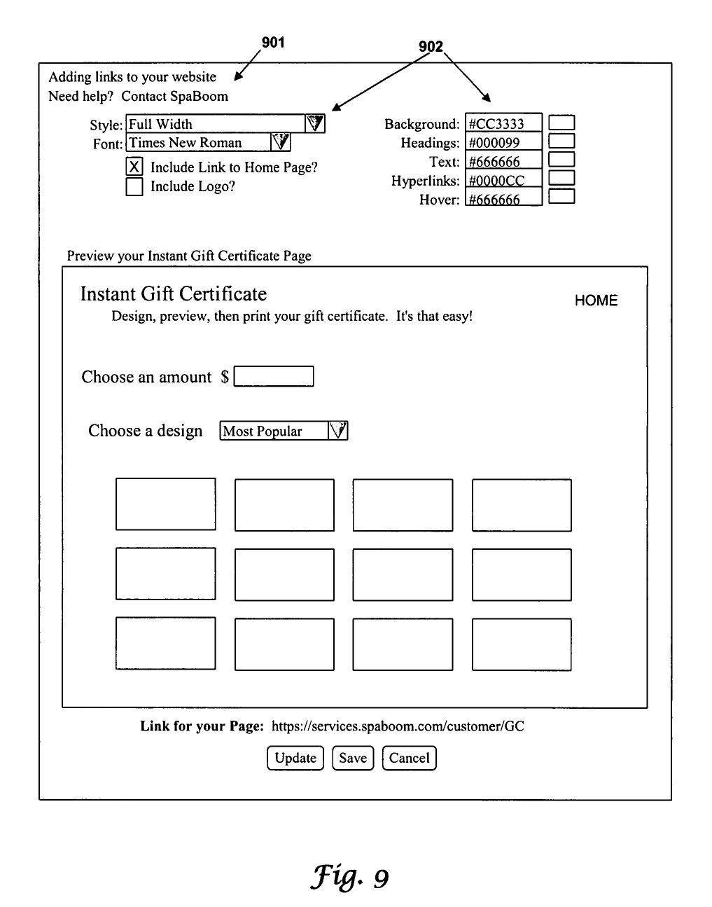

FIG. 9 illustrates a web page that a facilitator can serve to an organization for designing an instant gift certificate offer page in accordance with aspects of certain embodiments. Starting from the top of the page, there are two links 901. The topmost link “Adding links to your website” can take a user to a page of directions for embedding links. “Contact SpaBoom” can take the user to a web form for sending questions and comments or can cause an email window to open that is already addressed to “SpaBoom”. Here, SpaBoom is the facilitator and the user is a person working on behalf of the organization that intends to use SpaBoom to facilitate the issuing of gift certificates.

Next, web page global settings 902 can be set. “Style” and “Font” refer to text appearance. The right side specifies colors of well known web page elements. As is known to those practiced in the arts of web page design or computer graphics, a page “Background” can be set to a reddish “#CC3333” pixel value. A rectangle displaying a swatch of the selected color is positioned to the right of the pixel value.

Two selection boxes appear underneath the “Font” input. “Include Link to Home Page?” is checked and, as can be seen in the preview of the “Instant Gift Certificate” web page, a “HOME” link appears in the top left corner. No logo appears in the preview because “Include Logo” is not checked.

The instant gift certificate offer page that is being previewed is fairly simple. A customer can enter an amount and choose a design. Other gift certificate pages can include selections for a service, such as deep massage. The “Choose a design” drop down menu lets a customer select a category such as “Most Popular”, “Anniversary”, or “Valentines”. Three rows of four thumbnails of specific designs are shown under the “Choose a design” drop down menu. The specific thumbnails depend on the category.

A link to the instant gift certificate offer page appears under the preview. That is the link that the organization can place in its own web pages. A customer following the link is directed from the organizations web site to the “Instant Gift Certificate Page” hosted on the facilitator's web server. Alternatively, the facilitator can provide the web page to the organization in the form of computer files so that the organization can host the file itself.

Finally, there are three buttons at the bottom of the page. “Update” can cause the preview to be updated with the selected global settings 902. “Save” can cause work to be saved such as when the user is done designing the page. “Cancel” can cancel the work done since the last “Save”.

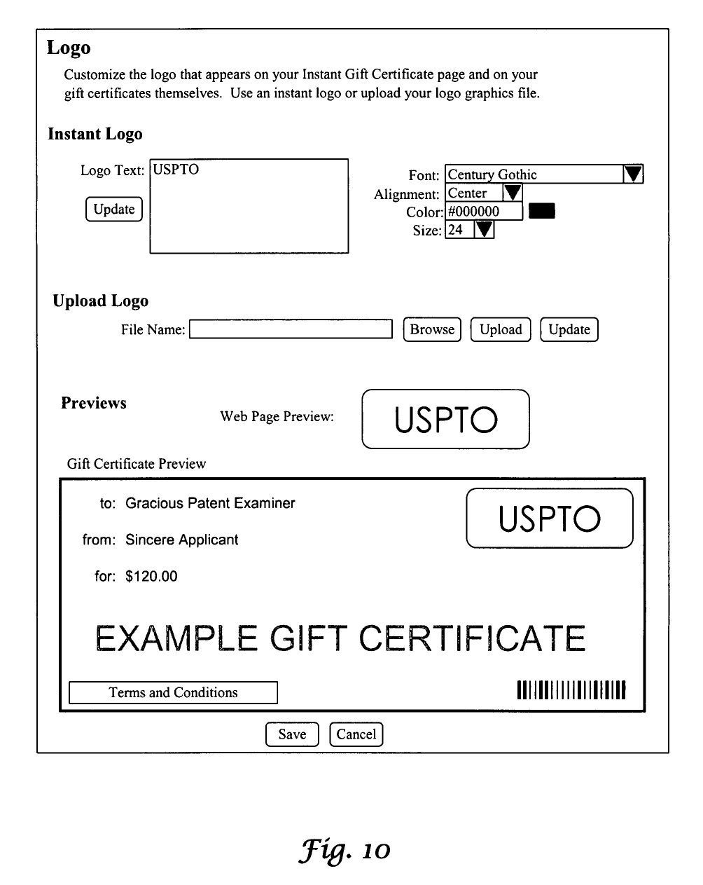

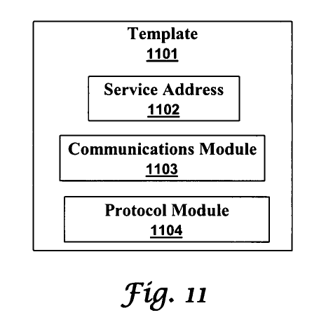

FIG. 10 illustrates a web page that a facilitator can serve to an organization for designing an instant logo and instant gift certificates in accordance with aspects of certain embodiments. An “Instant Logo” can be designed by entering text and choosing font, alignment, color and size. Here, a century gothic “USPTO” logo has been entered. Clicking the “Update” button can cause the logo to be presented in the previews. The web page preview shows how the logo would look if it were to appear on a web page such as on the “Instant Gift Certificate Page” of FIG. 9.

A graphic file containing a logo can be uploaded. Those practiced in the art of uploading files from web forms or attaching files to web based email are familiar with the mechanics of selecting a file and using the “Browse” and “Upload” buttons. Another “Update” button is used to cause the uploaded logo to appear in the previews.

The “Gift Certificate Preview” shows a user what an instant gift certificate might look like. In this example, the upper left corner contains “To:”, “From:” and “For:” fields. The logo appears in the upper right. The lower left corner presents customized terms and conditions that have been chosen based on the organization's legal jurisdiction. Different terms and conditions can be presented that are based on a customer's legal jurisdiction as well. The lower right corner presents a bar code. The bar code can encode information including a gift certificate Id, a security code, and other data such as that in the GC Response 506 of FIG. 5. Clearly, data such as the gift certificate Id can be printed on a gift certificate outside of a bar code.

Finally, the “Save” and “Cancel” buttons can cause the designer's work to be saved or discarded. As with the “Instant Gift Certificate Page”, a gift certificate can be presented to a customer on a web page served by the organization or the facilitator.

FIG. 11 illustrates a high level block diagram of a template 1101 that a facilitator can provide an organization for sending instant gift certificate requests and receiving instant gift certificate responses in accordance with aspects of certain embodiments. The illustrated template 1101 is an example of a template that can be used although there are doubtless many other template designs that can also, and equivalently, be used. The template 1101 contains a service address 1102, communications module 1103, and protocol module 1104. The service address can be the location on the internet to which requests can be sent and responses expected. For example, “request.spaboom.com:3030” specifies a host and a host port. A communications module 1103 can send and receive messages without understanding the content of the messages. The protocol module 1104 can understand the content of the message.

An example of using a template is that a facilitator provides an organization with a template. The template can be the same for all organizations or can be automatically customized for each organization. A customized template can provide the organization with a unique service address 1102 or other parameters that uniquely identify the organization to the facilitator.

When a customer attempts to purchase a gift certificate from the organization, the organization gathers the customer's information and uses the protocol module to form a gift certificate request. The communications module sends the request to the service address. The facilitator can process the request by billing the customer's credit card, producing a gift certificate Id and security code, and by entering the transaction in a database. The facilitator then sends a response.

Eventually, the communications module receives the response. The protocol module parses the response. One possibility is that the request was successfully processed. Another is that processing failed. The organization can react to the response by presenting an instant gift certificate or an error message.

The facilitator can send the proceeds from the gift certificate sale to organization immediately, aggregated daily, aggregated monthly, or by some other arrangement. The money can be transferred by written check, electronic funds transfer, or some other means.

Embodiments can be implemented in the context of modules. In the computer programming arts, a module (e.g., a software module) can be implemented as a collection of routines and data structures that perform particular tasks or implement a particular abstract data type. Modules generally can be composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term “module”, as utilized herein generally refers to software modules or implementations thereof. Such modules can be utilized separately or together to form a program product that can be implemented through signal-bearing media, including transmission media and recordable media.

The examples discussed above are intended to illustrate aspects of the embodiments. The phrases “an embodiment”, “some embodiments”, or “certain embodiments” do not necessarily refer to the same embodiment or any specific embodiment.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method comprising:
serving a facilitator website wherein an organization provides organization information to the facilitator website and wherein the organization information comprises an organization jurisdiction;
obtaining a gift certificate specification wherein the organization provides the gift certificate specification to the facilitator website;
obtaining customer information;
selecting customized terms and conditions based on the organization jurisdiction; and
producing an instant gift certificate based on the customer information, the organization information, and the gift certificate specification wherein the instant gift certificate comprises the customized terms and conditions.

2. The method of claim 1 wherein the customer information is obtained from the organization and wherein the organization obtained the customer information from a customer.

3. The method of claim 1 wherein the customer information is obtained from the customer and not from the organization.

4. The method of claim 1 further comprising:
producing and serving a gift certificate offer page; and
supplying the organization with a link to the gift certificate offer page wherein the organization publishes the link to a customer and wherein the customer follows the link to the gift certificate offer page.

5. The method of claim 1 wherein the customer information comprises a customer jurisdiction and wherein the customized terms and conditions are selected based on the organization jurisdiction and on the customer jurisdiction.

6. The method of claim 1 wherein the instant gift certificate further comprises an identifier.

7. The method of claim 1 further comprising providing a database that tracks the instant gift certificate wherein the instant gift certificate further comprises an identifier.

8. The method of claim 1 further comprising associating a password with the instant gift certificate wherein the password is required for redemption of the instant gift certificate.

9. A method comprising:
providing a facilitator website wherein an organization provides organization information to the facilitator website and wherein the organization information comprises an organization jurisdiction;
obtaining an instant gift certificate request from the organization wherein the instant gift certificate request comprises customer information;
selecting customized terms and conditions based on the organization jurisdiction; and
producing an instant gift certificate response based on the customer information and the organization information wherein the instant gift certificate comprises the customized terms and conditions.

10. The method of claim 9 further comprising producing a privacy policy based on the organization jurisdiction.

11. The method of claim 9 further comprising:
producing a gift certificate offer web page; and
supplying the organization with the gift certificate offer page wherein the organization serves the gift certificate offer page to a customer.

12. The method of claim 9 further comprising:
supplying the organization with an offer template comprising at least one template element wherein the organization produces and serves a gift certificate offer page comprising at least one of the at least one template element.

13. The method of claim 9 wherein the customer information comprises a customer jurisdiction and wherein the customized terms and conditions are selected based on the organization jurisdiction and on the customer jurisdiction.

14. The method of claim 9 wherein the gift certificate response comprises image data that encodes an instant gift certificate.

15. The system of claim 9 wherein the gift certificate response further comprises image data that encodes an identifier.

16. The system of claim 9 wherein the gift certificate response further comprises an identifier.

17. The method of claim 9 further comprising providing a database that tracks the instant gift certificate wherein the instant gift certificate further comprises an identifier.

18. The method of claim 9 wherein the gift certificate response further comprises a password wherein a person provides the password to redeem an instant gift certificate that is based on the gift certificate response.

19. A system comprising:
a means for obtaining organization information from an organization wherein the organization information comprises an organization jurisdiction;
a means for obtaining an instant gift certificate request from the organization wherein the instant gift certificate request comprises customer information;
a means for selecting customized terms and conditions based on the organization jurisdiction; and
a means for producing an instant gift certificate response based on the customer information and the organization information wherein the instant gift certificate comprises the customized terms and conditions.

20. The method of claim 19 wherein the customer information comprises a customer jurisdiction and wherein the customized terms and conditions selected are based on the organization jurisdiction and on the customer jurisdiction.
